(19) United States
(12) Patent Application Publication
(10) Pub. No.: US 2025/0214843 A1
(43) Pub. Date: Jul. 3, 2025

(54) METHOD FOR PRODUCING CARBON NANOTUBES

(71) Applicants: OSAKA SODA CO., LTD., Osaka-shi, Osaka (JP); MEIJO NANO CARBON CO., LTD., Nagoya-shi, Aichi (JP)

(72) Inventors: Daigo HIRAYAMA, Osaka-shi (JP); Akifumi NAKAGAWA, Osaka-shi (JP); Naoshi TANIYAMA, Osaka-shi (JP); Takeshi HASHIMOTO, Nagoya-shi (JP); Kei TAKANO, Nagoya-shi (JP)

(73) Assignees: OSAKA SODA CO., LTD., Osaka-shi, Osaka (JP); MEIJO NANO CARBON CO., LTD., Nagoya-shi, Aichi (JP)

(21) Appl. No.: 18/851,138

(22) PCT Filed: Mar. 29, 2023
(86) PCT No.: PCT/JP2023/013011

§ 371 Date: Sep. 26, 2024

(30) Foreign Application Priority Data
Mar. 29, 2022 (JP) 2022-052861

(51) Int. Cl. C01B 32/162; B01J 31/22; C01B 32/159

(52) U.S. Cl. CPC C01B 32/162; B01J 31/2295; C01B 32/159; B01J 2531/004; B01J 2531/842; C01B 2202/02; C01B 2202/30; C01P 2006/80

(57) ABSTRACT

There is provided a novel method capable of producing high-purity single-walled carbon nanotubes with high efficiency, without concern for a decrease in the strength of a reaction tube. A method for producing carbon nanotubes by floating catalyst chemical vapor deposition (FC-CVD), comprising the step of producing carbon nanotubes by heating a feed for carbon nanotubes in the presence of an iron-containing catalyst and an alkali metal compound.

### TECHNICAL FIELD

The present invention relates to a method for efficiently producing carbon nanotubes.

### BACKGROUND ART

Carbon nanotubes are tubular materials composed only of carbon with a nanometer-sized diameter. Carbon nanotubes have been attracting attention in terms of properties such as conductivity, thermal conductivity, mechanical strength, and chemical properties that are derived from their structural characteristics, and their practical use has been studied in various applications including the fields of electronics and energy.

There are three main methods for synthesizing carbon nanotubes: an arc discharge method, a laser evaporation method, and a chemical vapor deposition (CVD) method. Of these, unlike the arc discharge method and the laser evaporation method, the CVD method uses a gaseous carbon source instead of a solid carbon source, and therefore, the carbon source can be continuously injected into the reactor, which is a suitable method for mass synthesis. In addition, it is an excellent synthesis method in terms of high purity of the obtained carbon nanotubes and low production cost.

Of the CVD methods, floating catalyst CVD (FC-CVD) is a method particularly suitable for synthesizing single-walled carbon nanotubes having many excellent properties such as extremely high electrical and thermal conductivity as compared with multi-walled carbon nanotubes.

More specific examples of the method for producing carbon nanotubes by floating catalyst CVD include a method for producing single-walled carbon nanotubes in which by-production of amorphous carbon is suppressed (Patent Literature 1); a method for producing high-purity single-walled carbon nanotubes (Patent Literature 2); and a method for producing single-walled carbon nanotubes in a high yield (Patent Literature 3).

High-purity single-walled carbon nanotubes can be produced by these methods for producing carbon nanotubes. However, the yield of carbon nanotubes has been only a few percent, and these methods have failed to mass-produce single-walled carbon nanotubes.

Studies aimed at synthesizing multi-walled carbon nanotubes with high efficiency are also known, in which alkali metals are added as promoters to main transition metal catalysts (Non Patent Literatures 1 and 2). Multi-walled carbon nanotubes generally have a higher yield than that of single-walled carbon nanotubes. These studies applied to supported catalyst substrate CVD have also achieved yields of more than several tens of percent. However, these studies have provided a limited promoting effect, which is at most double the effect using a system without an alkali metal.

It has been reported (Non Patent Literature 3) that replacing an alumina (Al₂O₃) reaction tube by a mullite (Al₄+2×Si₂−2×O₁₀₋ₓ (x: 0 to 0.4)) reaction tube promotes the reaction on the reactor surface made of mullite, leading to doubling of the yield of carbon nanotubes. However, even though the yield has approximately doubled, Si, a component of the reaction tube, has been detected in the resulting carbon nanotubes, and the inclusion of Si has been concluded as due to fragments of the reaction tube. This raises concern for the durability of the mullite reaction tube in a high temperature range (for example, 1250° C. or more).

### CITATION LIST

### Patent Literature

Patent Literature 1: JP 5046078 B
Patent Literature 2: JP 4968643 B
Patent Literature 3: JP 2007-246309 A

### Non Patent Literature

Non Patent Literature 1: “The effect of alkaline doped catalysts on the CVD synthesis of carbon nanotubes” Phys. Status Solidi B 248, No. 11 2471-2474 (2011)
Non Patent Literature 2: “CVD-synthesis of multiwall carbon nanotubes over potassium-doped supported catalysts” Applied Catalysis A: General 344, 191-197 (2008)
Non Patent Literature 3: “Carbon nanotube synthesis and spinning as macroscopic fibers assisted by the ceramic reactor tube” Scientific Reports volume 9, Article number: 9239 (2019)

### SUMMARY OF INVENTION

### Technical Problem

The present invention has been made in view of the foregoing problem, and an object of the present invention is to provide a novel method capable of producing high-purity single-walled carbon nanotubes with high efficiency, without concern for a decrease in the strength of a reaction tube.

### Solution to Problem

The present inventors have found that high-purity single-walled carbon nanotubes can be produced with high efficiency, using a method for producing carbon nanotubes by floating catalyst chemical vapor deposition (FC-CVD), in which carbon nanotubes are produced by heating a feed for carbon nanotubes in the presence of an iron-containing catalyst and an alkali metal compound.

The inventors have also found that even when using a reaction tube made of a material with excellent strength at high temperature, such as alumina or SiC, the method of the present invention is capable of producing high-purity single-walled carbon nanotubes more safely at lower temperature, with high efficiency.

The present invention has been completed by further research based on such findings.

That is, according to the present invention, the following aspects of the invention are provided:

Item 1. A method for producing carbon nanotubes by floating catalyst chemical vapor deposition (FC-CVD), comprising the step of:
producing carbon nanotubes by heating a feed for carbon nanotubes in the presence of an iron-containing catalyst and an alkali metal compound.

Item 2. The method according to item 1, wherein an alkali metal species of the alkali metal compound comprises at least one selected from the group consisting of lithium, sodium, potassium, and cesium.

Item 3. The method according to item 1 or 2, wherein the alkali metal compound is at least one selected from the group consisting of phosphates, acetates, chlorides, sulfates, carbonates, tetraborate hydrates, silicates, and hydroxides of lithium, sodium, potassium, and cesium.

Item 4. The method according to any one of items 1 to 3, wherein an amount of the alkali metal compound supplied is 0.01 parts by mass or more and 15 parts by mass or less, per 100 parts by mass of the feed for carbon nanotubes.

Item 5. The method according to any one of items 1 to 4, wherein the iron-containing catalyst is ferrocene.

Item 6. The method according to any one of items 1 to 5, wherein the step of producing carbon nanotubes is performed in a ceramic reaction tube.

Item 7. The method according to item 6, wherein the ceramic reaction tube comprises silicon carbide.

### Advantageous Effects of Invention

The method for producing carbon nanotubes according to the present invention is capable of producing high-purity single-walled carbon nanotubes with high efficiency. Furthermore, according to the present invention, even when using a reaction tube made of a material with excellent strength in a high temperature range, such as alumina or SiC, it is possible to produce high-purity single-walled carbon nanotubes more safely at lower temperature, with high efficiency.

### BRIEF DESCRIPTION OF DRAWINGS

FIG. 1 is a schematic view showing an apparatus for producing carbon nanotubes by floating catalyst chemical vapor deposition (FC-CVD).

### DESCRIPTION OF EMBODIMENTS

Hereinafter, a method for producing carbon nanotubes according to the present invention will be described in detail.

The method for producing carbon nanotubes according to the present invention is a method for producing carbon nanotubes by floating catalyst chemical vapor deposition (FC-CVD).

Floating catalyst chemical vapor deposition (FC-CVD) is one of the CVD methods, in which a catalyst is introduced into a heated reaction tube without using a substrate as a support of the catalyst and allowed to chemically react with a carbon source in a state of being suspended and flowed in a vapor phase in which a carrier gas flows, so as to grow carbon nanotubes (CNTs) in a suspended state.

The method for producing carbon nanotubes (CNTs) of the present invention comprises the step of producing carbon nanotubes by heating a feed for carbon nanotubes in the presence of an iron-containing catalyst and an alkali metal compound.

In the method for producing carbon nanotubes of the present invention, high-purity single-walled carbon nanotubes can be produced with high efficiency, by heating the feed for carbon nanotubes in the presence of the iron-containing catalyst and the alkali metal compound (that is, bringing the feed for carbon nanotubes into contact with the iron-containing catalyst and the alkali metal compound, in a heated environment).

For example, carbon nanotubes can be produced by introducing (supplying) the feed for carbon nanotubes into a reaction tube used for floating catalyst chemical vapor deposition (FC-CVD), and bringing the feed into contact with the iron-containing catalyst and the alkali metal compound, in a heated environment.

As the feed (carbon source) for carbon nanotubes, a liquid or gaseous carbon compound can be used. As specific examples, methane, ethane, propane, ethylene, propylene, acetylene, and the like are preferably used as the gaseous carbon compound. As the liquid carbon compound, alcohols such as methanol and ethanol, aliphatic hydrocarbons such as hexane, cyclohexane, and decalin, and aromatic hydrocarbons such as benzene, toluene, and xylene are preferably used. Particularly preferably, ethylene, benzene, toluene, and decalin are used. Any of these carbon compounds may be mixed or used in combination.

The iron-containing catalyst is preferably a metallocene compound such as ferrocene, iron chloride, a metal acetylacetonate such as acetylacetonato iron, or a metal carbonyl such as iron carbonyl, more preferably a metallocene compound such as ferrocene, and particularly preferably ferrocene. The iron-containing catalysts may be used alone or in combinations of two or more.

In the present invention, the lower limit of the amount of the iron-containing catalyst supplied is preferably 2 parts by mass or more, more preferably 4 parts by mass or more, and still more preferably 6 parts by mass or more, per 100 parts by mass of the carbon source. The upper limit is preferably 14 parts by mass or less, more preferably 12 parts by mass or less, and still more preferably 10 parts by mass or less. Preferred ranges of the amount of the iron-containing catalyst supplied include from 2 to 14 parts by mass, from 2 to 12 parts by mass, from 2 to 10 parts by mass, from 4 to 14 parts by mass, from 4 to 12 parts by mass, from 4 to 10 parts by mass, from 6 to 14 parts by mass, from 6 to 12 parts by mass, and from 6 to 10 parts by mass, per 100 parts by mass of the carbon source.

The iron-containing catalyst can be used in combination with another catalyst. The other catalyst is preferably a transition metal compound or transition metal fine particles. The transition metal is preferably cobalt, nickel, palladium, platinum, or rhodium, and more preferably cobalt or nickel. The transition metal compound as the other catalyst is preferably a metallocene compound such as ferrocene or nickelocene, a chloride such as cobalt chloride, a metal acetylacetonate, or a metal carbonyl, and more preferably a metallocene compound such as cobaltocene or nickelocene. The other catalysts may be used alone or in combinations of two or more.

Each of the iron-containing catalyst and the transition metal fine particle has a particle size of preferably 0.1 to 50 nm, and more preferably 0.3 to 15 nm. The particle size of the fine particle can be measured using a transmission electron microscope.

Methods for supplying the iron-containing catalyst are not specifically limited as long as they can supply the iron-containing catalyst into the system (into, for example, the reaction tube), and include a method in which the iron-containing catalyst is supplied in a state dissolved in a solvent; and a method in which the iron-containing catalyst in a vaporized state is introduced into the reaction tube. In the present invention, it is preferred to use the method in which the iron-containing catalyst is supplied in a state dissolved in a solvent. When the iron-containing catalyst is used in combination with another catalyst, the same methods as above may be used.

In the method in which the iron-containing catalyst is supplied in a state dissolved in a solvent, the solvent is not specifically limited, but is preferably the liquid carbon compound used as the carbon source.

In the method of the present invention, it is preferred to further add a sulfur compound in order to promote the reaction for producing carbon nanotubes. Examples of the sulfur compound include an organic sulfur compound and an inorganic sulfur compound. Examples of the organic sulfur compound include thiols, thiophene, and benzothiophene, and examples of the inorganic sulfur compound include elemental sulfur, carbon disulfide, and hydrogen sulfide. The sulfur compounds may be used alone or in combinations of two or more.

Methods for adding the sulfur compound are not specifically limited, and include adding the sulfur compound by dissolving it in the liquid carbon compound used as the carbon source.

In the present invention, the lower limit of the amount of the sulfur compound supplied is preferably 0.1 parts by mass or more, more preferably 0.25 parts by mass or more, and still more preferably 0.5 parts by mass or more, per 100 parts by mass of the carbon source. The upper limit is preferably 5 parts by mass or less, more preferably 3 parts by mass or less, and still more preferably 2 parts by mass or less. Amounts less than the lower limits may fail to achieve the promoting effect, while amounts more than the upper limits may lead to quality degradation due to a large amount of the sulfur compound remaining in the carbon nanotubes, and reduced yield due to an increased load in the purification process. Preferred ranges of the amount of the sulfur compound supplied include from 0.1 to 5 parts by mass, from 0.1 to 3 parts by mass, from 0.1 to 2 parts by mass, from 0.25 to 5 parts by mass, from 0.25 to 3 parts by mass, from 0.25 to 2 parts by mass, from 0.5 to 5 parts by mass, from 0.5 to 3 parts by mass, and from 0.5 to 2 parts by mass, per 100 parts by mass of the carbon source.

The alkali metal compound in the method of the present invention is preferably a phosphate, an acetate, a chloride, a sulfate, a carbonate, a tetraborate hydrate, a silicate, or a hydroxide of lithium, sodium, potassium, or cesium; more preferably a chloride, a sulfate, a carbonate, a tetraborate hydrate, a silicate, or a hydroxide of lithium, sodium, potassium, or cesium; still more preferably a chloride, a sulfate, a carbonate, a tetraborate hydrate, a silicate, or a hydroxide of sodium, potassium, or cesium; and particularly preferably a chloride, a carbonate, or a hydroxide of potassium or cesium. The alkali metal compounds may be used alone or in combinations of two or more.

Manners of supplying the alkali metal compound are in no way limited, and examples include a method in which powder is supplied directly into the reaction tube; a method in which an aqueous solution of the alkali metal compound is prepared and sprayed through a nozzle; and a method in which the alkali metal compound is vaporized and supplied into the reaction tube. Because of easy handling, the method in which an aqueous solution of the alkali metal compound is prepared and sprayed through a nozzle and the method in which the alkali metal compound is vaporized and supplied into the reaction tube are preferred.

In the present invention, the lower limit of the amount of the alkali metal compound supplied is preferably 0.01 parts by mass or more, more preferably 0.03 parts by mass or more, still more preferably 0.05 parts by mass or more, and particularly preferably 0.07 parts by mass or more, per 100 parts by mass of the carbon source. The upper limit is preferably 15 parts by mass or less, more preferably 12 parts by mass or less, still more preferably 10 parts by mass or less, and particularly preferably 8 parts by mass or less. Amounts less than the lower limits may fail to achieve the promoting effect, while amounts more than the upper limits may lead to quality degradation due to a large amount of the alkali metal compound remaining in the carbon nanotubes, and reduced yield due to an increased load in the purification process. Preferred ranges of the amount of the alkali metal compound supplied include from 0.01 to 15 parts by mass, from 0.01 to 12 parts by mass, from 0.01 to 10 parts by mass, from 0.01 to 8 parts by mass, from 0.03 to 15 parts by mass, from 0.03 to 12 parts by mass, from 0.03 to 10 parts by mass, from 0.03 to 8 parts by mass, from 0.05 to 15 parts by mass, from 0.05 to 12 parts by mass, from 0.05 to 10 parts by mass, from 0.05 to 8 parts by mass, from 0.07 to 15 parts by mass, from 0.07 to 12 parts by mass, from 0.07 to 10 parts by mass, and from 0.07 to 8 parts by mass, per 100 parts by mass of the carbon source.

As the carrier gas, an inert gas such as hydrogen, argon, helium, or nitrogen can be used, and these carrier gases may be used alone or as a mixture.

In the present invention, the step of producing carbon nanotubes may be performed in a reactor. The reactor is not specifically limited as long as it can efficiently produce carbon nanotubes; preferably, either a horizontal reactor or a vertical reactor is used to perform the reaction, and more preferably, a vertical reactor is used to perform the reaction. The reactor preferably has, for example, a tubular shape.

Materials of the reactor in the present invention are not specifically limited as long as they have excellent strength in a high temperature range, and include, for example, ceramics such as alumina, silica, silicon carbide, silicon nitride, aluminum nitride, mullite, and ferrite; glasses such as soda glass, lead glass, borosilicate glass, and quartz glass; and metals such as stainless steel and carbon steel. In the present invention, ceramics are preferably used. Specifically, preferred materials are alumina, silicon carbide, and mullite, more preferred are alumina and silicon carbide, and still more preferred is silicon carbide.

The reaction temperature in the present invention is not specifically limited as long as the temperature allows the iron-containing catalyst and the carbon source to react efficiently, but is preferably 1200 to 1800° C., more preferably 1200 to 1500° C., and still more preferably 1200 to 1300° C. These ranges of the reaction temperature advantageously improve the G/D ratio, which represents the rate of defects in the carbon nanotubes, and improve the proportion of single-walled carbon nanotubes. In contrast, an excessively high temperature reduces the proportion of single-walled carbon nanotubes, while an excessively low temperature reduces the yield of the carbon nanotubes significantly.

The carbon nanotubes produced by the method of the present invention have a carbon purity of preferably 80% or more, more preferably 84% or more, and particularly preferably 88% or more.

An intensity ratio G/D of G band and D band of the carbon nanotubes produced by the method of the present invention is preferably 40 or more, more preferably 60 or more, and particularly preferably 70 or more. G/D is measured by a Raman spectrometer and calculated from the peak intensity ratio of the G band (near 1590 cm⁻¹) and the D band (near 1300 cm⁻¹) in a Raman spectrum obtained by resonance Raman scattering measurement (excitation wavelength 532 nm). A higher G/D ratio indicates a smaller number of defects in the structure of the carbon nanotubes.

The carbon nanotubes produced by the method of the present invention have a diameter of preferably 3.0 nm or less, and more preferably 2.5 nm or less. The carbon nanotubes of the present invention may be either single-walled carbon nanotubes or multi-walled carbon nanotubes; however, high-purity single-walled carbon nanotubes can be more advantageously produced according to the method of the present invention.

The proportion of single-walled carbon nanotubes (SWCNTs) in the carbon nanotubes obtained according to the method of the present invention is preferably 75% by mass or more, more preferably 80% by mass or more, still more preferably 85% by mass or more, and particularly preferably 90% by mass or more.

### EXAMPLES

The present invention will be hereinafter described in more detail with reference to examples; however, the present invention is in no way limited thereto.

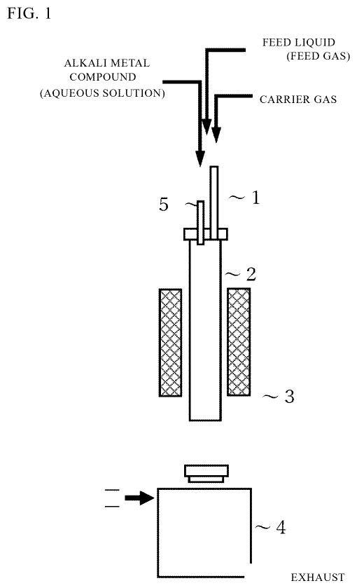

Carbon nanotubes were produced using an apparatus shown in FIG. 1. FIG. 1 shows a feed spray nozzle 1, a reaction tube 2, a heater 3, a carbon nanotube collector 4, and an alkali metal compound supply nozzle 5.

Carbon nanotubes were synthesized using the following reagents and the like:
Toluene: Kanto Chemical Co., Inc.
Ferrocene: FUJIFILM Wako Pure Chemical Corporation
Thiophene: Tokyo Chemical Industry Co., Ltd.
Hydrogen: Iwatani Corporation
Sodium chloride: FUJIFILM Wako Pure Chemical Corporation
Sodium tetraborate decahydrate: FUJIFILM Wako Pure Chemical Corporation
Sodium silicate: FUJIFILM Wako Pure Chemical Corporation
Potassium tetraborate tetrahydrate: FUJIFILM Wako Pure Chemical Corporation
Potassium chloride: FUJIFILM Wako Pure Chemical Corporation
Potassium hydroxide: FUJIFILM Wako Pure Chemical Corporation
Potassium carbonate: FUJIFILM Wako Pure Chemical Corporation
Cesium hydroxide: Nacalai Tesque, Inc.

### Example 1

Carbon nanotubes were synthesized using the carbon nanotube production apparatus shown in FIG. 1. As the reaction tube 2, a tube made of atmospheric pressure sintered silicon carbide (SiC) with an inner diameter of 50 mm, an outer diameter of 60 mm, and a length of 1400 mm was used. Argon gas was passed into the tube, and the reaction tube was heated to 1250° C. by the heater 3 (effective heating length: 900 mm) in an argon stream. Thereafter, instead of supplying argon, hydrogen gas was supplied as a carrier gas. A liquid mixture of 100 parts by mass of toluene as a carbon source, 8.08 parts by mass of ferrocene as an iron-containing catalyst, and 0.91 parts by mass of thiophene as a sulfur compound was supplied from the nozzle 1, while an aqueous solution of sodium chloride (amount of sodium chloride supplied: 0.10 parts by mass) as an alkali metal compound was supplied from the nozzle 5. The reaction time was 3 hours. As a result of the reaction, a deposit of black carbon nanotubes formed in the carbon nanotube collector 4 placed below the reaction tube.

The carrier gas was changed from hydrogen to argon and then cooled to room temperature. Thereafter, the deposit was collected from the collector and evaluated as set forth below. The results are shown in Table 1.

### <Yield>

Yield was calculated by dividing the mass of collected carbon nanotubes by the mass of the carbon source supplied. The equation for calculation is as follows:

$$Yield ( \% ) = ( mass of collected carbon nanotubes / mass of carbon source ) \times 100$$

### <G/D Ratio>

Using a laser Raman microscope (RAMANtouch VIS-NIR-DIS; Nanophoton Corporation), measurement was performed at a laser wavelength of 532 nm, and the intensity ratio G/D of the G band and the D band, which represents the crystallinity of carbon nanotubes, was calculated from the peak intensity ratio of the G band (near 1590 cm⁻¹) and the D band (near 1300 cm

### <Carbon Purity>

Using a simultaneous thermogravimetric differential thermal analyzer (STA7200RV; Hitachi High-Tech Science), about 7 mg of a sample was heated from room temperature to 900° C. at a heating rate of 10° C./min at an air flow rate of 200 cc/min, and then the rate of weight loss in the temperature range from room temperature to 900° C. was evaluated.

### Example 2

The same procedure as in Example 1 was repeated, except that sodium tetraborate decahydrate was supplied as the alkali metal compound in an amount of 0.51 parts by mass.

### Example 3

The same procedure as in Example 1 was repeated, except that sodium silicate was supplied as the alkali metal compound in an amount of 5.07 parts by mass.

### Example 4

The same procedure as in Example 1 was repeated, except that potassium tetraborate tetrahydrate was supplied as the alkali metal compound in an amount of 1.48 parts by mass.

### Example 5

The same procedure as in Example 1 was repeated, except that potassium chloride was supplied as the alkali metal compound in an amount of 0.46 parts by mass.

### Example 6

The same procedure as in Example 1 was repeated, except that potassium hydroxide was supplied as the alkali metal compound in an amount of 0.07 parts by mass.

### Example 7

The same procedure as in Example 1 was repeated, except that potassium carbonate was supplied as the alkali metal compound in an amount of 0.17 parts by mass.

### Example 8

The same procedure as in Example 1 was repeated, except that cesium hydroxide was supplied as the alkali metal compound in an amount of 0.44 parts by mass.

### Comparative Example 1

The same procedure as in Example 1 was repeated, except that the heating temperature was 1300° C., and no alkali metal compound was supplied.

### Comparative Example 2

The same procedure as in Comparative Example 1 was repeated, except that the heating temperature was 1300° C., and the reaction tube 2 was a mullite reaction tube (mass of Al₂O₃+SiO₂=98%, Al₂O₃/SiO₂=1.8, bulk density=2.7).

### Comparative Example 3

The same procedure as in Comparative Example 1 was repeated, except that the heating temperature was 1200° C., and the reaction tube 2 was a mullite reaction tube (mass of Al₂O₃+SiO₂=98%, Al₂O₃/SiO₂=1.8, bulk density=2.7).

TABLE 1

| | | | | | | | | | | Comp. | Comp. | Comp. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 | Ex. 3 |
| Toluene | | 100 | 100 | 100 | 100 | 100 | 100 | 100 | 100 | 100 | 100 | 100 |
| Ferrocene | | 8.08 | 8.08 | 8.08 | 8.08 | 8.08 | 8.08 | 8.08 | 8.08 | 8.08 | 8.08 | 8.08 |
| Thiophene | | 0.91 | 0.91 | 0.91 | 0.91 | 0.91 | 0.91 | 0.91 | 0.91 | 0.91 | 0.91 | 0.91 |
| Sodium Chloride | | 0.10 | | | | | | | | | | |
| Sodium Tetraborate Decahydrate | | | 0.51 | | | | | | | | | |
| Sodium Silicate | | | | 5.07 | | | | | | | | |
| Potassium Tetraborate Tetrahydrate | | | | | 1.48 | | | | | | | |
| Potassium Chloride | | | | | | 0.46 | | | | | | |
| Potassium Hydroxide | | | | | | | 0.07 | | | | | |
| Potassium Carbonate | | | | | | | | 0.17 | | | | |
| Cesium Hydroxide | | | | | | | | | 0.44 | | | |
| Reaction Tube Material | | SiC | SiC | SiC | SiC | SiC | SiC | SiC | SiC | SiC | Mullite | Mullite |
| Reaction Temperature (° C.) | | 1250 | 1250 | 1250 | 1250 | 1250 | 1250 | 1250 | 1250 | 1300 | 1300 | 1200 |
| Evaluation | Yield (%) | 6 | 6 | 6 | 10 | 19 | 22 | 25 | 29 | 1 | 15 | 5 |
| | G/D | 77 | 70 | 68 | 55 | 110 | 92 | 66 | 94 | 60 | 80 | 85 |
| | Carbon Purity (%) | 75 | 86 | 86 | 89 | 93 | 93 | 93 | 96 | 37 | 93 | 90 |

As shown in Table 1, according to Examples 1 to 8, high-purity single-walled carbon nanotubes were produced with high efficiency, using the method for producing carbon nanotubes by floating catalyst chemical vapor deposition (FC-CVD), in which the carbon nanotubes were produced by heating the feed for carbon nanotubes in the presence of the iron-containing catalyst and the alkali metal compound. Furthermore, according to Examples 1 to 8, higher-yield and higher-quality carbon nanotubes were obtained even at a lower temperature, compared to the carbon nanotubes according to Comparative Examples 2 and 3, which used a reactor made of mullite. This shows that the reaction temperature was reduced by supplying the alkali metal compound, and the carbon nanotubes were produced more safely without concern for the strength.

### REFERENCE SIGNS LIST

1: Feed spray nozzle
2: Reaction tube
3: Heater
4: Carbon nanotube collector
5: Alkali metal compound supply nozzle

1. A method for producing carbon nanotubes by floating catalyst chemical vapor deposition (FC-CVD), comprising the step of:
producing carbon nanotubes by heating a feed for carbon nanotubes in the presence of an iron-containing catalyst and an alkali metal compound.

2. The method according to claim 1, wherein an alkali metal species of the alkali metal compound comprises at least one selected from the group consisting of lithium, sodium, potassium, and cesium.

3. The method according to claim 1, wherein the alkali metal compound is at least one selected from the group consisting of phosphates, acetates, chlorides, sulfates, carbonates, tetraborate hydrates, silicates, and hydroxides of lithium, sodium, potassium, and cesium.

4. The method according to claim 1, wherein an amount of the alkali metal compound supplied is 0.01 parts by mass or more and 15 parts by mass or less, per 100 parts by mass of the feed for carbon nanotubes.

5. The method according to claim 1, wherein the iron-containing catalyst is ferrocene.

6. The method according to claim 1, wherein the step of producing carbon nanotubes is performed in a ceramic reaction tube.

7. The method according to claim 6, wherein the ceramic reaction tube comprises silicon carbide.

8. The method according to claim 2, wherein the alkali metal compound is at least one selected from the group consisting of phosphates, acetates, chlorides, sulfates, carbonates, tetraborate hydrates, silicates, and hydroxides of lithium, sodium, potassium, and cesium.

9. The method according to claim 2, wherein an amount of the alkali metal compound supplied is 0.01 parts by mass or more and 15 parts by mass or less, per 100 parts by mass of the feed for carbon nanotubes.

10. The method according to claim 2, wherein the iron-containing catalyst is ferrocene.

11. The method according to claim 2, wherein the step of producing carbon nanotubes is performed in a ceramic reaction tube.
